(19) United States
(12) Patent Application Publication
(10) Pub. No.: US 2002/0193090 A1
(43) Pub. Date: Dec. 19, 2002

(54) System and method for dynamic sampling rate adjustment to minimize power consumption in wideband radios

(76) Inventors: Gary L. Sugar, Rockville, MD (US); William R. Seed, N. Potomac, MD (US); Yohannes Tesfai, Falls Church, VA (US); Chandra Vaidyanathan, Bethesda, MD (US)

Correspondence Address: COGNIO, INC., 101 ORCHARD RIDGE DRIVE, SUITE 350, GAITHERSBURG, MD, 20878, US

(21) Appl. No.: 10/151,616

(22) Filed: May 20, 2002

Related U.S. Application Data
(60) Provisional application No. 60/292,815, filed on May 23, 2001.

(51) Int. Cl. H04B 1/16

(52) U.S. Cl. 455/343; 455/127

(57) ABSTRACT

A system and method that minimizes power consumption in wideband radios by dynamically adjusting the sampling rates of an analog-to-digital converter to the minimum sampling rate required to support the operation in a wideband mode and operation a narrowband mode. The sampling rate is controlled according to an operating mode whereby the sampling rate for a wideband operating mode is greater than the sampling rate for a narrowband operating mode. The wideband operating mode is a mode in which energy for an entire frequency band is received and sampled by the analog-to-digital converter and the narrowband operating mode is a mode in which only a portion of the entire frequency band is received and sampled by the analog-to-digital converter.

This application claims priority to U.S. Provisional Application No. 60/292,815 filed May 23, 2001, the entirety of which is incorporated herein by reference.

### BACKGROUND OF THE INVENTION

Wideband Digital Radios (herein referred to as “wideband radios”) are devices that sample and digitize an entire band of RF signals using a single, wideband RF transceiver, and digitally process these signals using digital logic and/or software. Over the last ten years or so, wideband radios have been used primarily in cellular base-stations, where their main benefit has been to replace the circuitry required to implement multiple narrowband transceivers (one for each RF signal) with a single wideband transceiver used to process multiple signals.

Recently, wideband radios have been proposed for use in consumer-oriented short-range wireless communications products. For example, a wideband radio may be used in a personal computer (PC) to allow the PC to communicate using one or several wireless local area and personal area networking (WLAN and WPAN) protocols simultaneously.

Several differences exist in the implementation of wideband radios for consumer devices from the way they are implemented in cellular base-stations. One key difference comes from the requirement for low power consumption in consumer devices, which is not a critical design factor for base-stations. Consumer devices such as laptop PCs, digital cameras, and personal digital assistants (PDAs) typically are powered by a small battery, and therefore power consumption for such devices is critical in order to preserve power.

Two of the key contributors to power consumption in wideband radios are the high-speed analog-to-digital (ADC) and digital-to-analog (DAC) converters used to digitize the radio signals. For example, in a wideband radio used to digitize signals in the 2.4 GHz Industrial, Scientific and Medical (ISM) band, it can be shown that the ADC, even if implemented using state-of-the-art 0.13 micron CMOS technology, consumes over 40% of the receiver's total current drain. By contrast, in a narrowband mode, the radio can operate certain components at lower power.

It is desirable to improve the power consumption of a wideband radio communication device that operates part of the time in a wideband mode and part of the time in a narrowband mode.

### SUMMARY OF THE INVENTION

A system and method are provided that minimizes power consumption in wideband radios by dynamically adjusting the sampling rates of an analog-to-digital converter to the minimum sampling rate required to support the operation in a wideband mode and operation a narrowband mode. The sampling rate is controlled according to an operating mode whereby the sampling rate for a wideband operating mode is greater than the sampling rate for a narrowband operating mode. The wideband operating mode is a mode in which energy for an entire frequency band is received and sampled by the analog-to-digital converter and the narrowband operating mode is a mode in which only a portion of the entire frequency band is received and sampled by the analog-to-digital converter.

Furthermore, a system and method are provided for dynamically assigning RF carrier frequencies to a number of RF signals to minimize the composite RF bandwidth that those RF signals span, and therefore the required sampling rate, to support the communication of these signals. Other features are described herein, which are useful to minimize power consumption of a wideband radio system.

Other objects and advantages of the present invention will become more readily apparent when reference is made to the following description in conjunction with the accompanying drawings.

### BRIEF DESCRIPTION OF THE DRAWINGS

FIG. 1 is a block diagram of a wideband radio transceiver system.

FIG. 2 is a more specific block diagram of a wideband radio transceiver system.

FIG. 3 is a state diagram that represents the change in operational modes of the radio transceiver system in an exemplary embodiment.

FIG. 4 is a graphical diagram illustrating re-assignment of a carrier frequency in a frequency band.

FIG. 5 is a timing diagram illustrating timing for a sleep mode.

### DETAILED DESCRIPTION OF THE INVENTION

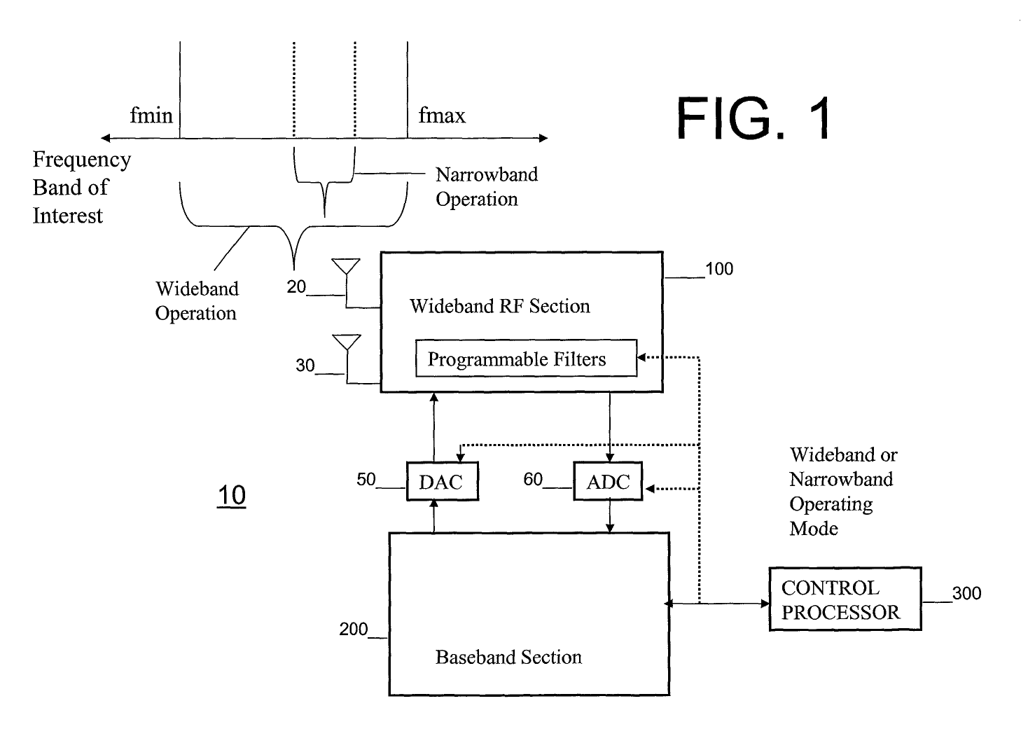

Referring first to FIG. 1, a block diagram of a radio transceiver system 10 is shown, in which there is a wideband radio frequency (RF) section 100 connected to at least one receive antenna 20 and at least one transmit antenna 30, a baseband section 200 and a control processor 300. At least one digital-to-analog converter (DAC) 50 and at least one analog-to-digital converter (ADC) 60 are coupled between RF section 100 and the baseband section 200.

The baseband section 200 and the control processor 300 may be integrated into one integrated circuit (IC) chip based on a processing core. The wideband RF section 100 may be implemented as a separate IC. The DAC 50 and ADC 60 may be integrated as part of the baseband section 200 depending on a particular implementation. The control processor 300 controls operation of the RF section 100 and baseband section 200, and also supplies information to be transmitted to the baseband section, and accepts information recovered from signals received by the RF section 100 and recovered by the baseband section 200. The DAC 50 converts digital signals output by the baseband section 200 (representing information to be transmitted) to analog signals for processing by the RF section 100 and transmission by the transmit antenna 30. The ADC 60 converts analog signals output by the RF section 100 (representing received signals) to digital signals for processing by the baseband section 200. In addition, in the wideband RF section 100, there are programmable filters (for anti-aliasing after downconversion and reconstruction prior to upconversion).

The radio transceiver system 10 is capable of operating in several modes, including a wideband operating mode and a narrowband operating mode. The control processor 300 determines the current operating mode, either based on its own logic or in response to commands from a host device interfaced to the control processor. Generally, in the wideband operating mode, the RF section 100 is controlled to receive energy spanning an entire frequency band (from fₘᵢₙ to fₘₐₓ) or to transmit one or more signals that span the frequency band. For example, the frequency band may be an unlicensed band, such as the unlicensed bands at 2.4 GHz and 5 GHz. Examples of signals that may be present in the unlicensed bands are the IEEE 802.11x family of signals, Bluetooth™ signals, cordless telephones, etc. The baseband section 200 comprises firmware to perform the necessary baseband processing to transmit and receive signals in one or more signal protocols or standards, such as those mentioned above.

One use for a wideband operating mode is to sample the entire frequency band to gather sufficient information about the signals active in the frequency band in order to identify and classify those signals for managing the access to the frequency band by those devices competing for use of it. Specifically, in the wideband mode, a device can sample an entire frequency band (or a substantially portion of it) at one instant of time (or for an time interval) which is useful to obtain perform analysis on both the time and frequency characteristics of activity in the frequency band.

Another use for the wideband operating mode is to simultaneously receive and transmit signals of the same or different communication protocols or standards in the frequency band. Still another use of the wideband operating mode is to transmit or receive a single wideband high data rate signal that occupies the entire frequency band.

In the narrowband operating mode, only a portion of the frequency band is of interest. For example, in narrowband operation, only a single signal of any type is transmitted and/or received in the frequency band. Narrowband operation may occur at any suitable portion of the frequency band, and need not be a fixed portion.

Depending on the operating mode of the radio transceiver system 10, the sampling rates of the DAC 50 and ADC 60 can be adjusted to minimize power consumption. This is particularly useful if the radio transceiver system 10 is to be deployed in a mobile communication device that is powered by a rechargeable or otherwise limited power supply.

An example of the sampling rates for the ADC and DAC are shown in the table below. In this example, the frequency band is the 2.4 GHz unlicensed band or the 5 GHz unlicensed band, for example.

| | |
|---|---|
| Transmit | Receive |

| Operating | Fs | BW | Fs | BW |
|---|---|---|---|---|
| Mode | (MHz) | (MHz) | (MHz) | (MHz) |
| Narrowband | 40 | 20 | 40 | 20 |
| Wideband | 100 | 80 | 100 | 80 |

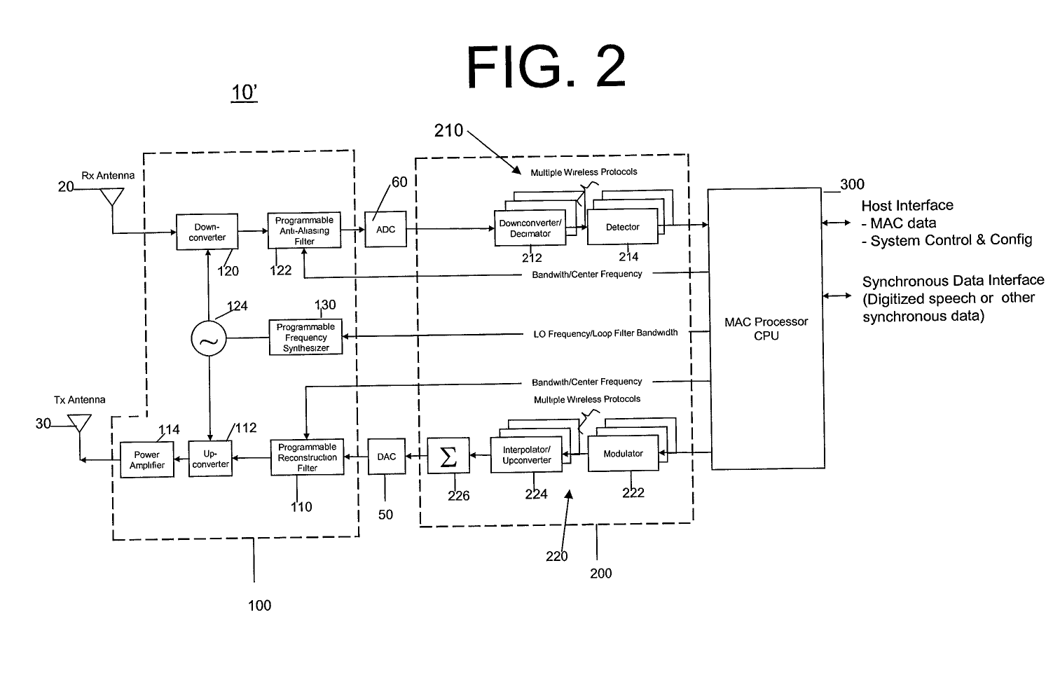

The block diagram in FIG. 2 shows as an example a system architecture for a radio frequency transceiver system providing for the capability to simultaneously transmit and receive one or more signals in the frequency band of the same or different protocol types or standards. This is a special case of the more generalized block diagram of FIG. 1, but many if not all of the specific features and functions described hereinafter for use with the more specific system architecture of FIG. 2, are useful in connection with a more generalized system architecture of FIG. 1.

Turning to FIG. 2, a block diagram of system 10′ will be described. The RF section 100 comprises analog hardware including a transmit subsection and a receive subsection. The transmit subsection comprises a reconstruction filter 110 for analog conversion of the transmit signal, an upconverter 112 which converts a baseband or low intermediate frequency (IF) signal to the transmit frequency band and a power amplifier (PA) 114 which amplifies the transmit RF signal to a desired output level. The receive subsection comprises a downconverter 120 that converts the received RF signal to baseband or a low IF and an anti-aliasing filter 122. The downconverter 120 is essentially a mixer that down-mixes the received signal based on a mixing signal that the local oscillator 124 supplies. Similarly, the upconverter 112 is a mixer that up-mixes the transmit signal to the appropriate RF transmit based on a frequency mixing signal supplied to it by the local oscillator 124.

The baseband section 200 includes configurable baseband processing firmware 210 and 220 to perform digital frequency translation, sampling rate conversion, modulation, and detection for one or multiple baseband signals, such as signals in the IEEE 802.11x family, Bluetooth Tm signals, and others. Specifically, the baseband processing section 210 comprises one or more downconverter/decimators 212 and one or more detectors 214 for each of the signal protocols supported by the radio transceiver. Similarly, the baseband processing section 220 comprises one or more modulators 222 and one or more interpolators/upconverters 224 to support the same signal protocols, and a summer 226 which adds the output of the interpolators/upconverters 224.

The control processor 300 is shown as a medium access control (MAC) processor and software to support MAC protocols and to control system operation. The bandwidth of the anti-aliasing and reconstruction filters 122 and 110, respectively, may be programmed from the MAC processor in a baseband or low IF implementation; the center frequency is programmable in a low IF implementation. The bandwidth of the loop filter used by a frequency synthesizer 130 is also programmable. The programmable frequency synthesizer 130 controls the output frequency of the local oscillator 124.

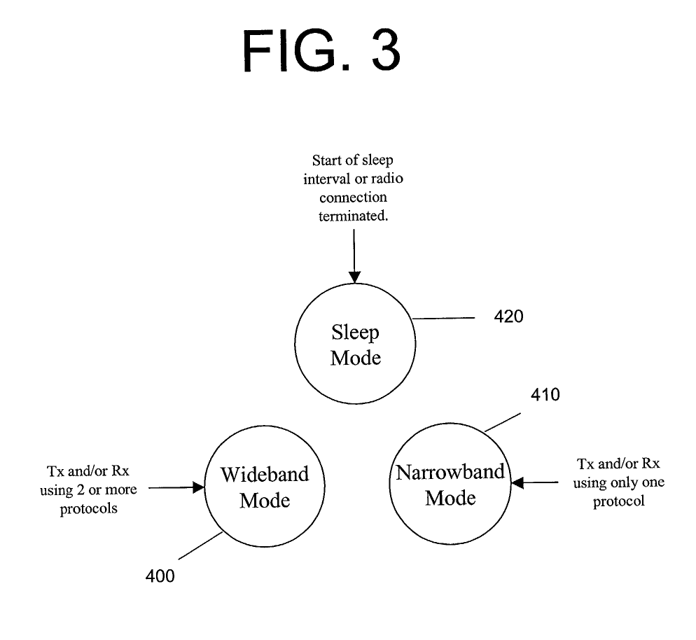

As an example, the wideband radio system 10′ supports three basic operational modes: wideband mode 400, narrowband mode 410 and sleep mode 420. The MAC processor initiates changes between the operating modes based on the required level of activity, as represented in the state diagram shown in FIG. 3. The wideband and narrowband modes are similar to the operating modes described above in connection with FIG. 1, but may have additional functionality.

Wideband Mode 400:

Wideband mode is used when support for the simultaneous operation of 2 or more protocols is required, or multiple instances/channels of the same protocol, such as multiple 802.11 signals. In this mode, the converter sampling rates and the bandwidth of the reconstruction and anti-aliasing filters are adjusted to the minimum values required to reconstruct the signals in the frequency band spanned by all supported protocols without aliasing. In the wideband operating mode, the entire frequency band will be downconverted, and knowledge of the signals that are active in the entire frequency band is gained through the processing modules in the baseband processing section 210. That is, if a signal of a particular type (protocol) drops off or becomes active in the frequency band, the constant processing of baseband information with each of the processing modules will detect this situation and supply this information to the control processor 300.

The control processor may update the filter bandwidths and sampling rates in this mode as needed whenever there is a change in the number of active protocols. For example, the control processor would decrease the filter bandwidth and converter sampling rate when 2 simultaneous direct-sequence spread-spectrum 802.11b WLAN protocols are required instead of 3. In a low IF implementation, whenever there is a change in sampling rate, the frequency synthesizer is tuned to create the desired IF frequency (at least half the bandwidth of the RF band of interest), and the center frequency for the reconstruction and anti-aliasing filters is adjusted appropriately.

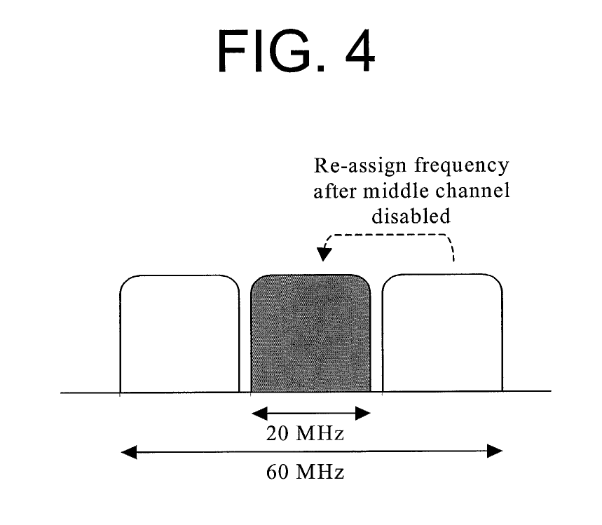

Whenever possible, the control processor assigns or reassigns the carrier frequencies for each of the supported protocols in such a way as to minimize the total amount of spectrum that they span. By “compacting” the spectrum in this way, the sampling rate required to support a given number of protocols is minimized, and therefore, so is the power consumption. For example, as shown in FIG. 4, consider a scenario in which there are three contiguous 20 MHz channels of 802.11b in operation and the middle channel is no longer needed. The Nyquist bandwidth required to support all three 802.11b protocols is approximately 60 MHz. After the middle channel is disabled or becomes inactive, the above approach would re-assign the right channel frequency to the frequency slot previously occupied by the middle channel, since in this case only 40 MHz of Nyquist bandwidth would be required to support the two remaining protocols (60 MHz of Nyquist bandwidth would have been required if the right channel were not re-assigned). A command signal to assign or re-assign the channel frequencies can be sent by a master device in a network, such as an access point (AP) or by any terminal in a network to all other terminals, or the intelligence to assign or re-assign can be generated locally based on information gathered by processing signals in the wideband mode.

Since frequent adjustment of the frequency synthesizer is not required in wideband mode (the downconversion of frequency-hopped signals such as Bluetooth is implemented digitally in this mode), the processor selects a relatively small loop bandwidth for the frequency synthesizer to minimize phase noise and spurious tones.

In the wideband mode, the control processor may synchronize the transmission events or receiving events when it is necessary to transmit or receive multiple signals of the same or different protocols. In this way, the DAC 50 and ADC 60 (and/or other implicated components) are operated in their higher power/faster rate mode at substantially the same time intervals, and then powered down or adjusted to the lower power/slower rate mode when the transmission or receiving event of multiple signals is completed. By aligning the transmission or reception events, the DAC 50, ADC 60 and/or other components are operated in higher power modes at minimum duty cycle (i.e., less frequently), and therefore consume less overall power.

Narrowband Mode 410:

Narrowband mode is used to lower power consumption when support for only one protocol is required. In this mode, the bandwidth of the reconstruction and anti-aliasing filters are lowered and the DAC 50 and ADC 60 are clocked at the minimum sampling rate necessary to support the desired protocol. To support the Bluetooth protocol, for example, which has an RF signal bandwidth of approximately 2 MHz, the reconstruction and anti-aliasing filter bandwidths are set to 2 MHz, and the ADC and DAC are clocked at 4 MHz. In a low IF implementation, the frequency synthesizer is tuned to create the desired IF frequency (at least half the bandwidth of the narrowband RF signal), and the center frequency for the reconstruction and anti-aliasing filters is adjusted appropriately. To support frequency-hopped protocols such as Bluetooth in Narrowband Mode, the frequency synthesizer is tuned periodically from the baseband hardware or MAC processor at the hop frequency. When frequency-hopped protocols are required in this mode, the processor increases the loop bandwidth of the frequency synthesizer to support the required settling time.

Sleep Mode 420:

In sleep mode, all radio circuitry is powered down to minimize current consumption when there is no protocol activity. Sleep mode may be invoked either (1) when a radio connection is not required, or (2) during a sleep interval specified by a particular protocol or set of protocols.

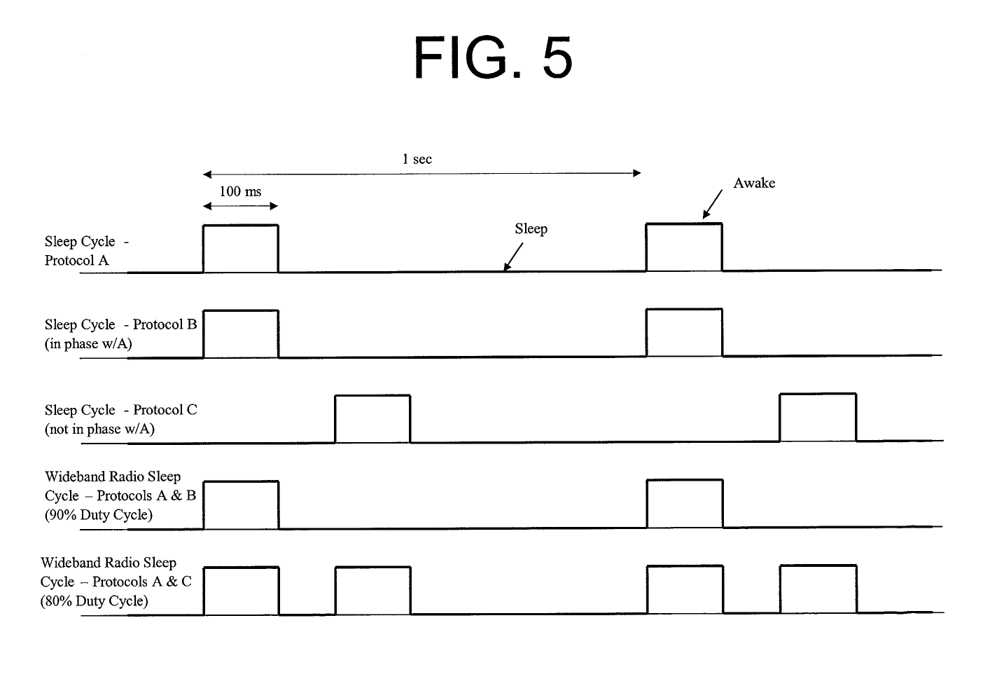

When multiple protocols are active and the radio has the ability to control the sleep interval timing for these protocols, the radio aligns the sleep intervals (in both phase and frequency) to maximize sleep time. For example, for two active protocols that are awake for 100 ms per second, the radio aligns the sleep intervals in phase to ensure a 90% sleep duty cycle. This is shown in FIG. 5. The last row of FIG. 5 also shows that if the radio were to instead align these intervals out-of-phase in this example, the sleep duty cycle would be only 80%.

To summarize, described herein is a system and method for minimizing power consumption of a radio communication device capable of operating in a wideband mode and a narrowband mode. The system comprises an analog-to-digital converter that converts a baseband or intermediate frequency signal to a digital signal for further processing, and a control processor coupled to the digital-to-analog converter. The control processor initiates changes between a wideband operating mode in which energy for an entire frequency band is received and a narrowband operating mode in which only a portion of the entire frequency band is received, and wherein the control processor supplies a command signal to the analog-to-digital converter to change a sampling rate thereof according to the operating mode whereby the sampling rate for the wideband operating mode is greater than the sampling rate for the narrowband operating mode. Generally, the control processor supplies a command signal to the analog-to-digital converter in the wideband mode to adjust a sampling rate of the analog-to-digital converter to a minimum value sufficient to process several signals of the same or different type expected to be present in the frequency band or to a minimum value sufficient to process a single signal that occupies substantially all of the frequency band. When there is a change in the number of signals of the same or different type in the frequency band, the control processor updates the sampling rate of the analog-to-digital converter. Similarly, in the transmit section, the control processor may control a digital-to-analog converter in the wideband operating mode to adjust its sampling rate to a minimum value sufficient to process several signals of the same of different type to be transmitted simultaneously in the frequency band or to a minimum value sufficient to process a single signal that will occupy substantially all of the frequency band when transmitted. When there is a change in the number of signals of the same or different type in the frequency band, the control processor in the wideband mode updates the sampling rate of the digital-to-analog converter.

Similar control is applied to a programmable anti-aliasing filter in the receive section and a programmable reconstruction filter in the transmit section to adjust the bandwidth of those filters according to the operating mode. In the wideband mode, the bandwidth of these filters are controlled to a minimum value sufficient to process several signals of the same or different type expected to be present (or for transmission) in the frequency band or to a minimum value sufficient to process a single signal that occupies substantially all of the frequency band.

In addition, the control processor in the wideband mode can supply a command signal to a programmable frequency synthesizer to create a desired intermediate frequency signal whenever there is a change in the sampling rate of the analog-to-digital and/or digital-to-analog converters. Moreover, when such a change is made to the programmable frequency synthesizer, the control processor supplies command signals to the programmable anti-aliasing filter and/or the programmable reconstruction filter to adjust their center frequencies according to the changes in the desired intermediate frequency. Yet another feature is to assign or reassign the carrier frequency of one or more signals simultaneously active in the frequency band so as to minimize the total amount of spectrum that the signals span in the frequency band.

The above description is intended by way of example only.

What is claimed is:

1. A radio communication system comprising:
a. an analog-to-digital converter that converts a baseband or intermediate frequency signal to a digital signal for further processing; and
b. a control processor coupled to the digital-to-analog converter, the control processor initiates changes between a wideband operating mode in which energy for an entire frequency band is received and a narrowband operating mode in which only a portion of the entire frequency band is received, and wherein the control processor supplies a command signal to the analog-to-digital converter to change a sampling rate thereof according to the operating mode whereby the sampling rate for the wideband operating mode is greater than the sampling rate for the narrowband operating mode.

2. The radio communication system of claim 1, wherein the control processor supplies a command signal to the analog-to-digital converter in the wideband mode to adjust a sampling rate of the analog-to-digital converter to a minimum value sufficient to process several signals of the same or different type expected to be present in the frequency band or to a minimum value sufficient to process a single signal that occupies substantially all of the frequency band.

3. The radio communication system of claim 1, wherein the control processor in the wideband mode updates the sampling rate of the analog-to-digital converter when there is a change in the number of signals of the same or different type in the frequency band.

4. The radio communication system of claim 1, and further comprising:
a digital-to-analog converter that receives a transmit signal to be transmitted and converts the transmit signal to an analog transmit signal for transmission;
wherein the control processor adjusts the sampling rate of the digital-to-analog converter such that it is greater in the wideband mode than in the narrowband mode.

5. The radio communication system of claim 4, wherein the control processor supplies a command signal to the digital-to-analog converter in the wideband operating mode to adjust its sampling rate to a minimum value sufficient to process several signals of the same of different type to be transmitted simultaneously in the frequency band or to a minimum value sufficient to process a single signal that will occupy substantially all of the frequency band when transmitted.

6. The radio communication device of claim 4, wherein the control processor in the wideband mode updates the sampling rate of the digital-to-analog converter when there is a change in the number of signals of the same or different type in the frequency band.

7. The radio communication system of claim 1, and further comprising a programmable anti-aliasing filter coupled to the control processor, wherein the control processor supplies a command signal to the programmable anti-aliasing filter to adjust the bandwidth thereof according to an operating mode of the radio communication system.

8. The radio communication system of claim 7, wherein the control processor supplies a command signal to the programmable anti-aliasing filter in the wideband mode to adjust the bandwidth to a minimum value sufficient to process several signals of the same or different type expected to be present in the frequency band or to a minimum value sufficient to process a single signal that occupies substantially all of the frequency band.

9. The radio communication system of claim 8, wherein the control processor in the wideband mode updates the bandwidth of the programmable anti-aliasing filter when there is a change in the number of signals of the same or different type in the frequency band.

10. The radio communication system of claim 4, and further comprising a programmable reconstruction filter coupled to the control processor, wherein the control processor supplies a command signal to the programmable reconstruction filter to adjust the bandwidth thereof according to an operation mode of the radio communication system.

11. The radio communication system of claim 10, wherein the control processor supplies a command signal to the programmable reconstruction filter in the wideband operating mode to adjust the bandwidth to a minimum value sufficient to process several signals of the same or different type to be transmitted in the frequency band or to a minimum value sufficient to process a single signal that occupies substantially all of the frequency band.

12. The radio communication system of claim 11, wherein the control processor in the wideband mode updates the bandwidth of the programmable reconstruction filter when there is a change in the number of signals of the same or different type in the frequency band.

13. The radio communication system of claim 1, and further comprising:
an RF section coupled to the analog-to-digital converter that converts an RF signal to the baseband or intermediate frequency signal and that converts the transmit signal to an RF signal for transmission for an antenna, the RF section comprising a local oscillator and a programmable frequency synthesizer coupled to the control processor and to the local oscillator that controls the local oscillator to operate at a center frequency for a desired intermediate frequency;
a digital-to-analog converter that receives a transmit signal to be transmitted and converts the transmit signal to an analog transmit signal for transmission; and
wherein the control processor in the wideband operating mode supplies a command signal to the programmable frequency synthesizer to create the desired intermediate frequency whenever there is a change in the sampling rate of the analog-to-digital and digital-to-analog converters.

14. The radio communication system of claim 13, wherein the RF section further comprises:
a programmable anti-aliasing filter coupled to the analog-to-digital converter and to the control processor;
a programmable reconstruction filter coupled to the digital-to-analog converter and to the control processor;
wherein the control processor supplies command signals to the programmable anti-aliasing filter and to the programmable reconstruction filter to adjust the center frequencies thereof according to changes in the desired intermediate frequency.

15. The radio communication system of claim 14, wherein the control processor supplies command signals to the programmable frequency synthesizer, to the programmable anti-aliasing filter and to the programmable reconstruction filter to assign or reassign the carrier frequency of one or more signals simultaneously active in the frequency band so as to minimize the total amount of spectrum that the signals span in the frequency band.

16. The radio communication system of claim 14, wherein the control processor issues command signals effective to reassign the carrier frequencies in response to an over-the-air signal containing a command sent by another communication device.

17. The radio communication system of claim 14, wherein the control processor in the narrowband operating mode supplies a command signal to the programmable frequency synthesizer to create the desired intermediate frequency and command signals to the programmable anti-aliasing filter and programmable reconstruction filter to adjust the center frequencies thereof.

18. The radio communication system of claim 1, wherein the control processor controls a powered-down sleep interval for the analog-to-digital converter and other components in the radio transceiver system, and when signals are active in the frequency band for two or more different signal types the control processor aligns sleep intervals for each of the different signal types as much as possible to maximize a sleep duty cycle of the analog-to-digital converter.

19. The radio communication system of claim 1, wherein in the wideband mode, the control processor synchronizes the transmission and/or reception of multiple signals of the same or different type so as minimize a higher data rate duty cycle of the analog-to-digital converter thereby minimizing power consumption.

20. A method of minimizing power consumption a radio communication system comprising steps of:
a. converting a baseband or intermediate frequency signal to a digital signal at a sampling rate; and
b. controlling the sampling rate according to an operating mode whereby the sampling rate for a wideband operating mode is greater than the sampling rate for a narrowband operating mode, wherein the wideband operating mode is a mode in which energy for an entire frequency band is received and sampled and the narrowband operating mode is a mode in which only a portion of the entire frequency band is received and sampled.

21. The method of claim 20, wherein the step of controlling comprises adjusting the sampling rate to a minimum value sufficient to process several signals of the same or different type expected to be present in the frequency band or to a minimum value sufficient to process a single signal that occupies substantially all of the frequency band.

22. The method of claim 20, wherein the step of controlling comprises updating the sampling rate when there is a change in the number of signals of the same or different type in the frequency band.

23. The method of claim 20, and further comprising the step of converting at a sampling rate a digital signal representing information to be transmitted to an analog signal for transmission, and wherein the step of controlling further comprises adjusting the sampling rate for digital-to-analog conversion to such that it is greater in the wideband mode than in the narrowband mode.

24. The method of claim 23, wherein the step of controlling comprises adjusting the sampling rate for digital-to-analog conversion to a minimum value sufficient to process several signals of the same of different type to be transmitted simultaneously in the frequency band or to a minimum value sufficient to process a single signal that will occupy substantially all of the frequency band when transmitted.

25. The method of claim 23, wherein the step of controlling comprises updating the sampling rate for digital-to-analog conversion when the there is a change in the number of signals of the same or different type in the frequency band.

26. The method of claim 20, wherein in the wideband operating mode, the step of controlling further comprises assigning a carrier frequency of one or more signals simultaneously active in the frequency band so as to minimize the total amount of spectrum that the signals span in the frequency band.

27. The method of claim 26, and further comprising the step of receiving an over-the-air signal containing a command sent by another communication device and the step of assigning the carrier frequency is responsive to the step of receiving the over-the-air signal.

28. The method of claim 20, wherein the step of controlling further comprises aligning powered-down sleep intervals for each of multiple signal types active in the frequency band to maximize a sleep duty cycle of one or more components in the radio communication system.

29. The method of claim 20, wherein the step of controlling further comprises aligning the transmission and/or reception of multiple signals of the same or different type so as to minimize a higher data rate duty cycle of the analog-to-digital conversion process thereby minimizing power consumption.
